(19) United States
(12) Patent Application Publication
(10) Pub. No.: US 2003/0193934 A1
(43) Pub. Date: Oct. 16, 2003

(54) Method and device for transmitting voice data in a mobile radio network

(76) Inventors: Ulrich Dropmann, Munchen (DE); Ralf Haferbeck, Munchen (DE); Eva-Maria Lanig, Germering (DE)

Correspondence Address: MORRISON & FOERSTER LLP, 1650 TYSONS BOULEVARD, SUITE 300, MCLEAN, VA, 22102, US

(21) Appl. No.: 10/220,822

(22) PCT Filed: Mar. 5, 2001
(86) PCT No.: PCT/DE01/00826

(30) Foreign Application Priority Data
Mar. 6, 2000 (DE) 100-10-887.303-06
Nov. 29, 2000 (DE) 100-59-330.5

(51) Int. Cl. H04L 12/66

(52) U.S. Cl. 370/355; 370/395.6

(57) ABSTRACT

The invention allows a voice data transmission in a mobile radio network to be optimized by means of a conversion device. Said device converts voice data that has been transmitted a TRAU 3 in a TFO mode into a packet data format, for transmission to an additional switching device via a long-distance switching network, thereby adapting the signaling if necessary.

Mobile radio networks are known to persons skilled in the art from, for example, the technical book by Jacek Biala, “Mobilfunk und intelligente Netze [Mobile Radio and Intelligent Networks],” Vieweg-Verlag [publisher], ISBN 3-528-15302-4, particularly pp. 124-125. A mobile radio network of this type can include a Transcoding and Rate Adaptation Unit (TRAU) in a BSS, which converts voice data coming from radio channels (at, for example, 16 Kbit/s full rate) for transmitting over 64-Kbit/s channels of a trunk junction (e.g., transmitting over a lengthy fixed-network segment, etc., for the core network of a mobile radio network). In a transmission from a mobile station via a TRAU, a trunk-junction telecommunications network and a further TRAU to another mobile station, the multiple conversions in the two TRAUs (that is, in the TRAU tandem) lead to a loss of quality; consequently, a so-called Tandem Free Operation (TFO), namely a transmission without a conversion in the two aforementioned TRAUs of a data path between two Mobile Stations MS, has been proposed for GSM mobile radio networks (GSM 03.53 version 8.00, R1999).

It is the object of the present invention to improve the efficiency of a transmission between end devices via a mobile radio network. The object is accomplished by the subjects of the respective independent claims.

A method and a conversion device (TFO-TRFO converter), respectively, according to the invention permit a simple, efficient, UMTS-compatible (3GPP TS 23.153) bandwidth utilization for a voice-data transmission on a trunk-junction segment.

The invention permits voice data that have been transmitted in a conventional manner from an end device to a TRAU, from the TRAU to a trunk-junction unit (switch MSC) in a format having a larger bandwidth (e.g., PCM-64 Kbit/s), and without transcoding (TFO), to be converted into a different packet-data format that is suitable for a trunk junction (e.g., switching to a different MSC), and conducted further, without it being necessary to modify the existing mobile radio-access network (GSM-BSS). Therefore, in a GSM network, it is possible to provide a transcoder-free operation (TrFO) at the end of a wide area network (for example, the core-network edge of a trunk-junction network).

A method and an apparatus according to the invention can particularly reformat the voice data to be transmitted, and execute a conversion of the signaling. Signaling data transmitted from a TRAU to an MSC or a conversion device (TFO-TRFO converter) can be used to determine parameters for an out-of-band codec negotiation (that is, negotiating the suitable codec), and/or for an IU-UP protocol codec mode modification (modification of the codec mode). A conversion device according to the invention permits an emulation of a TRAU (peer TRAU) in a TFO mode in order to respond to inquiries of a GSM-BSS TRAU. The voice data coming from the data stream of a transcoding and rate adaptation unit TRAU can particularly be converted into ATM-AAL2 or Internet-protocol packets for transmission via a trunk-junction telecommunications network (for example, a network between two MSCs) and, after a transmission (to another MSC, etc.), can correspondingly be reconverted into compressed voice data for further transmission to a TRAU in a TFO mode.

Further features and advantages of the invention ensue from the claims and the following description of an exemplary embodiment, with reference to the drawings. Shown are:

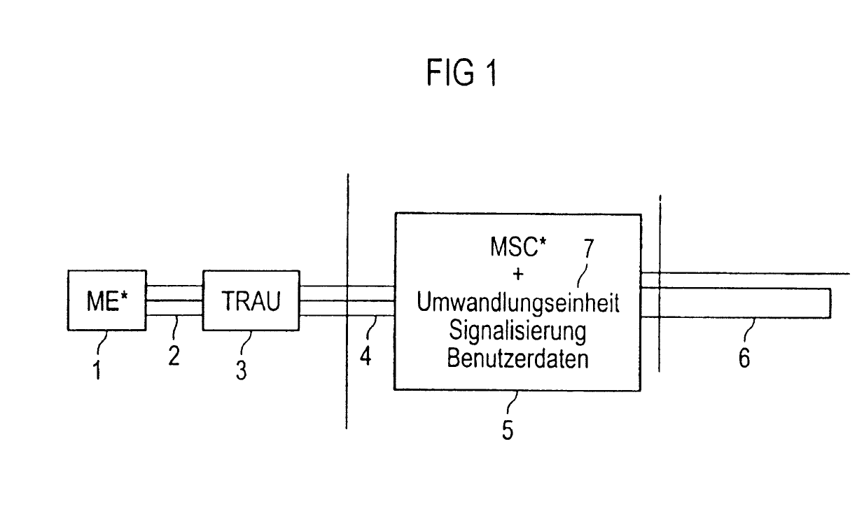

FIG. 1 a block diagram of the transmission of data from a mobile station via a TRAU to an MSC with a conversion device; and

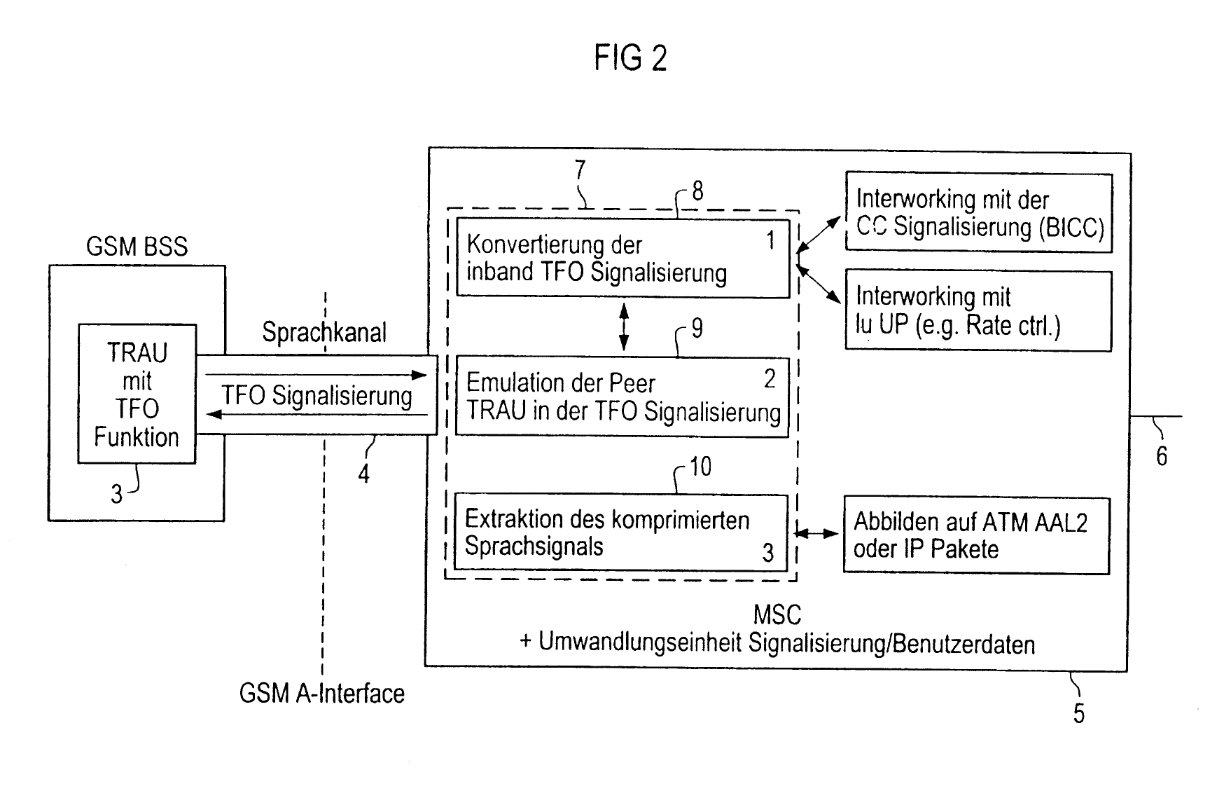

FIG. 2 a block diagram of the functional blocks of a conversion device, in particular.

FIG. 1 illustrates a mobile station 1, which utilizes a voice-data and signaling connection 2 (air interface) to a transcoding and rate adaptation unit TRAU 3. The TRAU 3 has a voice-data and signaling connection 4 to a switching device (MSC) 5. Disposed in the switching device MSC 5 is a conversion device (converter) according to the invention, which is used to repackage the voice data coming from the TRAU 3 (4) into ATM-AAL2 packets, IP packets or other packets for further transmission via a trunk-junction telecommunications network (to another MSC, etc.). The signaling data transmitted from the TRAU 3 are employed in generating the necessary signaling (inband and/or outband) for the transmission of voice data via the voice-data and signaling channel 6.

FIG. 2 clarifies the design of the conversion device in or at the switching device MSC 5. In FIG. 2, voice data and signaling data come from a radio system (for example, GSM-BSS) via a transcoding and rate adaptation unit TRAU 3 with a TFO capability (capability of transmitting without transcoding), and the channel 4 to an MSC having a conversion unit. On the side of the MSC 5, the conversion device 7 effects the conversion of the inband TFO signaling (transmitted via the channel 4) transmitted from a TRAU 3 via the channel 4 to the MSC 5 into an interworking with a CC signaling (BICC) and/or an interworking with an IU-UP protocol (for example, with respect to a rate control). Moreover, on the side of the switching device MSC, the conversion device 7 effects an emulation of a peer TRAU (9) in the TFO signaling mode. Voice data transmitted from the TRAU 3 via a voice channel/signaling channel 4 are extracted from the module 10 and transmitted further, as packet data (here ATM-AAL2 or IP), via a channel 6 to a further switching device, etc., via a trunk-junction telecommunications network.

Corresponding to a conversion of voice data and signaling data coming from a TRAU 3 in a converter 7 on the side of an MSC 5, a converter on the side of a further MSC converts the voice data and signaling data (after the signaling data and voice data have been transmitted via a channel 6) into a conventional form for transmission to a further TRAU.

Thus, it is possible to optimize the transmission of voice data in a mobile radio network with a conversion device that converts voice data coming from a TRAU in a TFO mode into a packet-data format for transmission, via a trunk-junction network, to a further switching device (MSC), thereby adapting the signaling as needed.

1. A method for transmitting voice data in a mobile radio network, characterized in that voice data that have been transmitted in a conventional manner (4) from an end device (ME 1) to a transcoding and rate adaptation unit (TRAU 3) are converted, without transcoding, into a format having a larger bandwidth (64 Kbit) by a conversion unit (TFO-TrFO converter 7), then transmitted from a trunk-junction unit (MSC 5) into a packet-switching telecommunications network (6) for transmission to a further switching device.

2. The method for transmitting voice data in a mobile radio network, particularly for transmitting voice data that have been transmitted in accordance with claim 1,
the voice data having been converted into a packet-data format by a conversion device, and transmitted from a switching device via a telecommunications network (6) in a packet-data format,
characterized in that the voice data are converted into a predetermined format (TFO) and transmitted to a transcoding and rate adaptation unit (TRAU) for being switched further to an end device.

3. The method according to one of the foregoing claims, characterized in that the packet-data format is an Internet-protocol format or an ATM-protocol format, particularly ATM-AAL2.

4. The method according to claim 1 or 2, characterized in that, in the conversion device, parameters are derived from the signaling transmitted from a transcoding and rate adaptation unit (TRAU 3) via a TFO voice-data channel to the conversion device, and are used to generate a signaling from the switching device to a further switching device.

5. The method according to one of the foregoing claims, characterized in that parameters are derived from the signaling transmitted from a transcoding and rate adaptation unit (TRAU 3) via a TFO voice-data channel to the conversion device, and are used to determine parameters for a codec parameter negotiation (codec negotiation) with devices of the mobile radio network, and/or for a codec mode modification.

6. The method according to one of the foregoing claims, characterized in that a conversion device (7) emulates a transcoding and rate adaptation unit (TRAU 3) in the non-TRAU transcoding mode (=TFO).

7. The method according to one of the foregoing claims, characterized in that the conversion device is located in a switching device (MSC) of the mobile radio network for transmitting voice data into/from a trunk-junction telecommunications network for the mobile radio network.

8. An apparatus (MSC 5; converter 7), particularly for executing the method according to one of the foregoing claims,
having an interface for data to be transmitted from and/or to a transcoding and rate adaptation unit (TRAU 3) in a non-transcoded format (TFO);
having an interface for voice data to be transmitted, in a packet-data format, from and/or to a trunk-junction telecommunications network (6) for a mobile radio network (1-5); and
having a conversion device (7; 10) for converting voice data between the two aforementioned formats (TFO, packet-data format).

9. The apparatus according to claim 8, characterized in that it further includes a device (8) for converting the signaling between a transcoding and rate adaptation unit (3) and the conversion device (7) into a format that is suitable for being switched further into the packet-switched trunk-junction network (6).

10. The apparatus according to claim 8 or 9, characterized in that it further includes a device (9) for emulating a TRAU in a TFO signaling mode, as opposed to a further TRAU (3) that is connected to the conversion device.

11. The apparatus according to one of the foregoing claims, characterized in that it is embodied such that it converts the voice data into a predetermined format (TFO) and transmits them to a transcoding and rate adaptation unit (TRAU) for further switching to an end device.

12. The apparatus according to one of the foregoing apparatus claims, characterized in that the packet-data format is an Internet-protocol format or an ATM-protocol format, particularly ATM-AAL2.

13. The apparatus according to one of the foregoing apparatus claims, characterized in that it is embodied such that, in the conversion device, parameters are derived from the signaling transmitted from a transcoding and rate adaptation unit (TRAU 3) via a TFO voice-data channel to the conversion device, and are used to generate a signaling from the switching device to a further switching device.

14. The apparatus according to one of the foregoing apparatus claims, characterized in that it is embodied such that parameters are derived from the signaling transmitted from a transcoding and rate adaptation unit (TRAU 3) via a TFO voice-data channel to the conversion device, and are used to determine parameters for a codec parameter negotiation (codec negotiation) with devices of the mobile radio network, and/or for a codec mode modification.

15. The apparatus according to one of the foregoing apparatus claims, characterized in that it is embodied such that a conversion device (7) emulates a transcoding and rate adaptation unit (TRAU 3) in the non-TRAU transcoding mode (TFO).

16. The apparatus according to one of the foregoing apparatus claims, characterized in that the conversion device is located in a switching device (MSC) of the mobile radio network for transmitting voice data into/from a trunk-junction telecommunications network for the mobile radio network.
